(19) United States
(12) Patent Application Publication
(10) Pub. No.: US 2012/0069018 A1
(43) Pub. Date: Mar. 22, 2012

(54) AR PROCESS APPARATUS, AR PROCESS METHOD AND STORAGE MEDIUM

(75) Inventors: Takashi YAMAYA, Tokyo (JP); Keiichi Sakurai, Tokyo (JP); Mitsuyasu Nakajima, Tokyo (JP); Yuki Yoshihama, Tokyo (JP)

(73) Assignee: Casio Computer Co., Ltd., Tokyo (JP)

(21) Appl. No.: 13/238,316

(22) Filed: Sep. 21, 2011

(30) Foreign Application Priority Data
Sep. 22, 2010 (JP) 2010-212633

(51) Int. Cl. G06T 17/00

(52) U.S. Cl. 345/420

(57) ABSTRACT

A generating unit generates a 3D model of an object based on pair images obtained for the same object. An extracting unit extracts plural first feature points from a to-be-synthesis 3D model and plural second feature points from a synthesis 3D model. An obtaining unit obtains a coordinate conversion parameter based on the plural first feature points and second feature points. A converting unit converts a coordinate of the synthesis 3D model in a coordinate in the coordinate system of the to-be-synthesis 3D model using the coordinate conversion parameter. A synthesizing unit synthesizes all converted synthesis 3D models with the to-be-synthesis 3D model, and unifies feature points. A storing unit stores the synthesized 3D model of the object and information on the unified feature points in a memory card, etc. The stored data is used in an AR process.

### CROSS-REFERENCE TO RELATED APPLICATION

This application claims the benefit of Japanese Patent Application No. 2010-212633 filed on Sep. 22, 2010, the entire disclosure of which is incorporated by reference herein.

### FIELD

This application relates generally to an AR technology that performs an AR (Augmented Reality) process on a picked-up image.

### BACKGROUND

An AR technology superimposes, on an image (picked-up image) of a real space picked up by a camera, information on an object, a CG (Computer Graphics) image, etc., and presents such an image to a user. Recently, research and development thereof become advance.

Such an AR technology gives a sensation as if an image or the like (a virtual object) superimposed on a picked-up image is present in a real space, so that it is necessary to precisely adjust the position of the superimposed virtual object in accordance with a change in the view point of the user (i.e., the position and posture of the camera).

For example, a technology is proposed which pastes a predetermined marker on an object and which traces such a marker in order to estimate the position and posture of a camera.

### SUMMARY

It is an object of the present invention to provide an AR process apparatus, an AR process method and a non-transitory computer-readable storage medium with an executable program stored thereon which can accept a wide variety of tangible entities as objects and which can precisely estimate the position and posture of a camera without using a marker in an AR process.

An AR process apparatus according to a first aspect of the present invention includes: an image obtaining unit that obtains a set of images which comprises two or more images having a parallax for an object; a generating unit that generates a 3D model of the object based on the set of images obtained by the image obtaining unit; an extracting unit which (a) selects a 3D model of the object initially generated by the generating unit as a to-be-synthesis 3D model, (b) extracts a plurality of first feature points from the to-be-synthesis 3D model, (c) selects a 3D model of the object subsequently generated by the generating unit as a synthesis 3D model, and (d) extracts a plurality of second feature points from the synthesis 3D model; an obtaining unit that obtains, based on (i) the plurality of first feature points of the to-be-synthesis 3D model and (ii) the plurality of second feature points of the synthesis 3D model extracted by the extracting unit, a coordinate conversion parameter that converts a coordinate of the synthesis 3D model into a coordinate in a coordinate system of the to-be-synthesis 3D model; a converting unit that converts the coordinate of the synthesis 3D model into the coordinate in the coordinate system of the to-be-synthesis 3D model using the coordinate conversion parameter obtained by the obtaining unit; a synthesizing unit which (a) generates a synthesized-3D model of the object by synthesizing a plurality of synthesis 3D models, whose coordinates have been converted by the converting unit, with the to-be-synthesis 3D model, and (b) unifies the feature points; and a storing unit that stores (a) the synthesized-3D model of the object generated by the synthesizing unit and (b) information indicating the unified feature points in a memory device.

An AR process apparatus according to a second aspect of the present invention includes: a registered-data obtaining unit that obtains 3D object data previously registered, which includes (a) a first 3D model of an object and (b) information indicating a plurality of feature points of the first 3D model; an image obtaining unit that obtains a set of images which comprises two or more images having a parallax for the object; a generating unit that generates a second 3D model of the object based on the set of images obtained by the image obtaining unit; an extracting unit that extracts a plurality of feature points from the second 3D model generated by the generating unit; an obtaining unit that obtains, based on (i) the plurality of feature points of the second 3D model extracted by the extracting unit and (ii) a plurality of feature points related to the 3D object data obtained by the registered-data obtaining unit, a coordinate conversion parameter that converts a coordinate of the first 3D model into a coordinate in a coordinate system of the second 3D model; an AR-data generating unit that generates AR data based on the coordinate conversion parameter obtained by the obtaining unit and the second 3D model; and an AR-image display unit that displays an image based on the AR data generated by the AR-data generating unit.

An AR process method according to a third aspect of the present invention includes: obtaining a set of images which comprises two or more images having a parallax for an object; generating a 3D model of the object based on the set of obtained images; selecting a 3D model of the object initially generated as a to-be-synthesis 3D model, and extracting a plurality of first feature points from the to-be-synthesis 3D model; selecting a 3D model of the object subsequently generated as a synthesis 3D model, and extracting a plurality of second feature points from the synthesis 3D model; obtaining, based on (i) the plurality of extracted first feature points of the to-be-synthesis 3D model and (ii) the plurality of extracted second feature points of the synthesis 3D model, a coordinate conversion parameter that converts a coordinate of the synthesis 3D model into a coordinate in a coordinate system of the to-be-synthesis 3D model; converting the coordinate of the synthesis 3D model into the coordinate in the coordinate system of the to-be-synthesis 3D model using the obtained coordinate conversion parameter; (a) generating a synthesized-3D model of the object by synthesizing a plurality of synthesis 3D models, whose coordinates have been converted, with the to-be-synthesis 3D model, and (b) unifying the feature points; and storing (a) the synthesized-3D model of the object generated and (b) information indicating the unified feature points in a memory device.

An AR process method according to a fourth aspect of the present invention includes: obtaining 3D object data previously registered, which includes (a) a first 3D model of an object and (b) information indicating a plurality of feature points of the first 3D model; obtaining a set of images which comprises two or more images having a parallax for the object; generating a second 3D model of the object based on the set of images obtained; extracting a plurality of feature points from the generated second 3D model; obtaining, based on (i) the plurality of extracted feature points of the second 3D model and (ii) a plurality of feature points related to the obtained 3D object data, a coordinate conversion parameter that converts a coordinate of the first 3D model into a coordinate in a coordinate system of the second 3D model; generating AR data based on the obtained coordinate conversion parameter and the second 3D model; and displaying an image based on the generated AR data.

A non-transitory computer-readable storage medium according to a fifth aspect of the present invention with an executable program stored thereon, wherein the program instructs a computer which controls an AR process apparatus to perform the following steps: obtaining a set of images which comprises two or more images having a parallax for an object; generating a 3D model of the object based on the set of obtained images; selecting a 3D model of the object initially generated as a to-be-synthesis 3D model, and extracting a plurality of first feature points from the to-be-synthesis 3D model; selecting a 3D model of the object subsequently generated as a synthesis 3D model, and extracting a plurality of second feature points from the synthesis 3D model; obtaining, based on (i) the plurality of extracted first feature points of the to-be-synthesis 3D model and (ii) the plurality of extracted second feature points of the synthesis 3D model, a coordinate conversion parameter that converts a coordinate of the synthesis 3D model into a coordinate in a coordinate system of the to-be-synthesis 3D model; converting the coordinate of the synthesis 3D model into the coordinate in the coordinate system of the to-be-synthesis 3D model using the obtained coordinate conversion parameter; (a) generating a synthesized-3D model of the object by synthesizing a plurality of synthesis 3D models, whose coordinates have been converted, with the to-be-synthesis 3D model, and (b) unifying the feature points; and storing (a) the synthesized-3D model of the object generated and (b) information indicating the unified feature points in a memory device.

A non-transitory computer-readable storage medium according to a sixth aspect of the present invention with an executable program stored thereon, wherein the program instructs a computer which controls an AR process apparatus to perform the following step: obtaining 3D object data previously registered, which includes (a) a first 3D model of an object and (b) information indicating a plurality of feature points of the first 3D model; obtaining a set of images which comprises two or more images having a parallax for the object; generating a second 3D model of the object based on the set of images obtained; extracting a plurality of feature points from the generated second 3D model; obtaining, based on (i) the plurality of extracted feature points of the second 3D model and (ii) a plurality of feature points related to the obtained 3D object data, a coordinate conversion parameter that converts a coordinate of the first 3D model into a coordinate in a coordinate system of the second 3D model; generating AR data based on the obtained coordinate conversion parameter and the second 3D model; and displaying an image based on the generated AR data.

### BRIEF DESCRIPTION OF THE DRAWINGS

A more complete understanding of this application can be obtained when the following detailed description is considered in conjunction with the following drawings, in which:

FIGS. 1A and 1B are diagrams showing an external shape of a stereo camera according to an embodiment of the present invention, and FIG. 1A is a front view and FIG. 1B is a rear view;

FIG. 2 is a block diagram showing an electrical configuration of a stereo camera according to the embodiment of the present invention;

FIG. 3 is a block diagram showing a functional configuration of the stereo camera of the embodiment relating to a 3D object registering mode;

FIG. 4 is a flowchart showing a flow of a 3D object registering process according to the embodiment of the present invention;

FIG. 5 is a flowchart showing a flow of a 3D model generating process according to the embodiment of the present invention;

FIG. 6 is a flowchart showing a flow of a camera position estimating process A according to the embodiment of the present invention;

FIG. 7 is a flowchart showing a flow of a coordinate-conversion-parameter obtaining process according to the embodiment of the present invention;

FIG. 8 is a flowchart showing a flow of a 3D model synthesizing process according to the embodiment of the present invention;

FIG. 9 is a block diagram showing a functional configuration of the stereo camera of the embodiment relating to a 3D object manipulating mode;

FIG. 10 is a flowchart showing a flow of an AR process according to the embodiment of the present invention; and

FIG. 11 is a flowchart showing a flow of a camera position estimating process B according to the embodiment of the present invention.

### DETAILED DESCRIPTION

A best mode of the present invention will be explained with reference to the accompanying drawings. In the present embodiment, an explanation will be given of an example case in which the present invention is applied to a digital stereo camera.

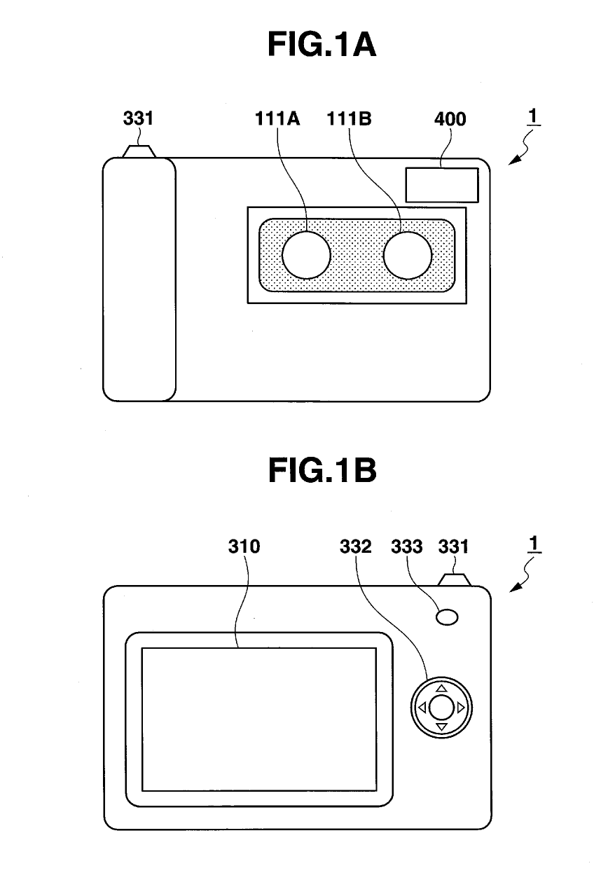

FIGS. 1A and 1B show an external shape of a stereo camera 1 according to the embodiment. As shown in FIG. 1A, the stereo camera 1 includes, at the front thereof, a lens 111A, a lens 111B, and a strobe light unit 400. Moreover, the stereo camera 1 includes a shutter button 331 at the top face thereof. When the stereo camera 1 is leveled in a direction in which the shutter button 331 is located upwardly, the lenses 111A and 111B are arranged with a predetermined clearance so that respective center positions are on the same line in the horizontal direction. The strobe light unit 400 emits strobe light to an object as needed. The shutter button 331 is for receiving a shutter operation instruction given from a user.

As shown in FIG. 1B, the stereo camera 1 also includes, at the rear thereof, a display unit 310, operation keys 332, and a power button 333. The display unit 310 is a liquid crystal display device, etc., and functions as an electric view finder that displays various screens necessary for the user to operate the stereo camera 1, a live view image at the time of image pickup, and a picked-up image.

The operation keys 332 include arrow keys and a set key, and receive various operations from the user, such as a mode change and a display change. The power button 333 receives turning on/off instruction of the stereo camera 1 from the user.

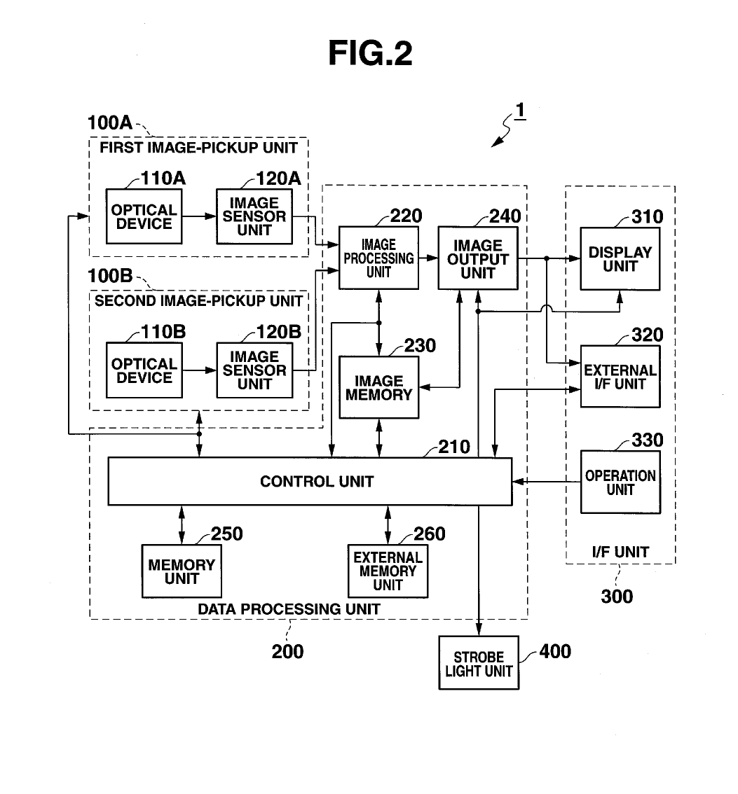

FIG. 2 is a block diagram showing an electrical configuration of the stereo camera 1. As shown in FIG. 2, the stereo camera 1 includes a first image-pickup unit 100A, a second image-pickup unit 100B, a data processing unit 200, an I/F unit 300, and the strobe light unit 400.

The first and second image-pickup units 100A and 100B bear a function of picking up images of an object, respectively. The stereo camera 1 is a so-called pantoscopic camera. The stereo camera 1 has the two image-pickup units, but the first and second image-pickup units 100A and 100B employ the same structure. A structure of the first image-pickup unit 100A will be added with an alphabet “A” at the end of a reference numeral, while a structure of the second image-pickup unit 100B will be added with an alphabet “B” at the end of a reference numeral.

As shown in FIG. 2, the first image-pickup unit 100A (the second image-pickup unit 100B) includes an optical device 110A (110B), an image sensor unit 120A (120B), etc. The optical device 110A (110B) includes, for example, a lens, a diaphragm mechanism, a shutter mechanism, and the like, and performs an optical operation related to an image pickup. That is, incident light is gathered and optical factors, such as a focal distance, a diaphragm, and a shutter speed, related to a field angle, focus, and exposure are adjusted by an operation of the optical device 110A (110B).

The shutter mechanism included in the optical device 110A (110B) is a so-called mechanical shutter. When a shutter operation is carried out only by an operation of an image sensor, it is fine if the optical device 110A (110B) does not include the shutter mechanism. Moreover, the optical device 110A (110B) is activated under a control by a control unit 210 to be discussed later.

The image sensor unit 120A (120B) generates an electric signal in accordance with incident light gathered by the optical device 110A (110B). The image sensor unit 120A (120B) is an image sensor like a CCD (Charge Coupled Device) or a CMOS (Complementally Metal Oxide Semiconductor) that performs photoelectric conversion. The image sensor unit 120A (120B) generates an electric signal in accordance with the intensity of received light through the photoelectric conversion, and outputs the generated electric signal to the data processing unit 200.

As explained above, the first and second image-pickup units 100A and 100B have the same structure. More specifically, individual specifications, such as a focal distance f of the lens, an F value, a diaphragm range of the diaphragm mechanism, the size, number of pixels, arrangement of the image sensor and the area of pixel, are same. When the first and second image-pickup units 100A and 100B are simultaneously operated, two images (pair images) are picked up for the same object. In this case, the first image-pickup unit 100A has a different optical axis position in the horizontal direction from that of the second image-pickup unit 100B.

The data processing unit 200 processes the electric signal generated by respective image-pickup operations of the first and second image-pickup units 100A and 100B, and generates digital data representing the picked-up images. Moreover, the data processing unit 200 performs image processing, etc., on the picked-up images. The data processing unit 200 includes a control unit 210, an image processing unit 220, an image memory 230, an image output unit 240, a memory unit 250, and an external memory unit 260, etc.

The control unit 210 includes a processor like a CPU (a Central Processing Unit), a main memory device like a RAM (Random Access Memory), etc. The processor runs a program stored in the memory unit 250 or the like, thereby controlling each unit of the stereo camera 1. Moreover, in the present embodiment, the control unit 210 realizes functions related to respective processes discussed later by running a predetermined program.

The image processing unit 220 includes, for example, an ADC (Analog-Digital-Converter), a buffer memory, and a processor for image processing (i.e., a so-called image processing engine). The image processing unit 220 generates digital data representing picked-up images based on electric signals generated by the image sensor units 120A and 120B, respectively. That is, when an analog electric signal output by the image sensor unit 120A (120B) is converted into a digital signal by the ADC and successively stored in the buffer memory, the image processing engine performs so-called development processing on the buffered digital data, thereby, for example, adjusting the image quality and compressing the data.

The image memory 230 includes a memory device like a RAM or a flash memory. The image memory 230 temporarily stores picked-up image data generated by the image processing unit 220 and image data processed by the control unit 210.

The image output unit 240 includes a circuit, etc., that generates an RGB signal. The image output unit 240 converts the image data stored in the image memory 230 into an RGB signal, and outputs the RGB signal to a display screen (e.g., the display unit 310).

The memory unit 250 includes a memory device like a ROM (Read Only Memory) or a flash memory, and stores a program and data necessary for causing the stereo camera 1 to operate. In the present embodiment, the memory unit 250 stores an operation program run by the control unit 210, etc., and data like parameters and arithmetic expressions necessary at the time of running such a program.

The external memory unit 260 is a memory device detachable from the stereo camera 1 like a memory card, and stores image data picked up by the stereo camera 1, 3D object data, and the like.

The I/F unit 300 is a processing unit that bears a function of an interface between the stereo camera 1 and a user or an external device. The I/F unit 300 includes the display unit 310, an external I/F unit 320, and an operation unit 330, etc.

The display unit 310 is, for example, as explained above, a liquid crystal display device, and displays various screens necessary for the user to operate the stereo camera 1, a live view image at the time of image-pickup, and a picked-up image, etc. In the present embodiment, the display unit 310 displays a picked-up image, etc., in accordance with an image signal (an RGB signal) from the image output unit 240.

The external I/F unit 320 includes, for example, a USB (Universal Serial Bus) connector and a video output terminal, outputs image data to an external computer device and outputs a picked-up image to an external monitor device that displays such a picked-up image.

The operation unit 330 includes various buttons provided on an external face of the stereo camera 1, generates an input signal in accordance with an operation given to the stereo camera 1 by the user, and transmits the input signal to the control unit 210. The buttons of the operation unit 330 include, as explained above, the shutter button 331, the operation keys 332, and the power button 333, etc.

The strobe light unit 400 includes, for example, a xenon lamp (a xenon flash). The strobe light unit 400 emits strobe light to the object under a control by the control unit 210.

The explanation was given of the configuration of the stereo camera 1 that realizes the present invention, but the stereo camera 1 also includes structural units necessary for realizing functions of a general stereo camera.

The stereo camera 1 employing the above-explained configuration registers a 3D model and feature point information through a process (a 3D object registering process) in a 3D object registering mode. Next, in a process (an AR process) in a 3D object manipulating mode, the stereo camera 1 estimates the position and posture thereof based on the feature point information registered in advance, performs an AR process on a picked-up image obtained at a present time, thereby generating AR data.

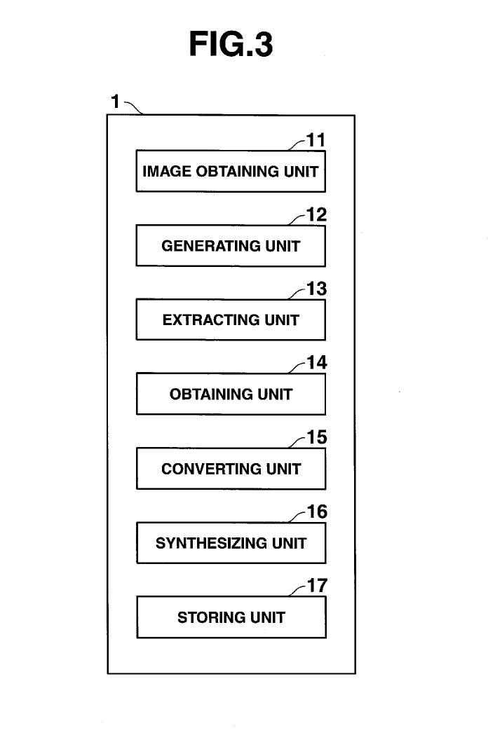

First, with reference to FIGS. 3 to 8, an operation related to the 3D object registering mode will be explained.

FIG. 3 is a block diagram showing a functional configuration of the stereo camera 1 for realizing an operation related to the 3D object registering mode.

In this operation, as shown in FIG. 3, the stereo camera 1 has an image obtaining unit 11, a generating unit 12, an extracting unit 13, an obtaining unit 14, a converting unit 15, a synthesizing unit 16, and a storing unit 17.

The image obtaining unit 11 obtains two images (pair images) having a parallax for the same object. The generating unit 12 generates a 3D model of the object based on the pair images obtained by the image obtaining unit 11.

The extracting unit 13 extracts a plurality of first feature points from a 3D model (to-be-synthesis 3D model) generated at first by the generating unit 12, and extracts a plurality of second feature points from a 3D model (synthesis 3D model) generated at a second time or later by the generating unit 12.

The obtaining unit 14 obtains a coordinate conversion parameter that converts the coordinates of the synthesis 3D model into coordinates in the coordinate system of the to-be-synthesis 3D model based on the plurality of first and second feature points extracted by the extracting unit 13.

The converting unit 15 converts the coordinates of the synthesis 3D model into coordinates in the coordinate system of the to-be-synthesis 3D model using the coordinate conversion parameter obtained by the obtaining unit 14.

The synthesizing unit 16 synthesizes all converted synthesis 3D models into a to-be-synthesis 3D model, and unifies the feature points. The storing unit 17 stores the 3D model of the object synthesized by the synthesizing unit 16 and information (feature point information) on the unified feature points in the external memory unit 260, etc.

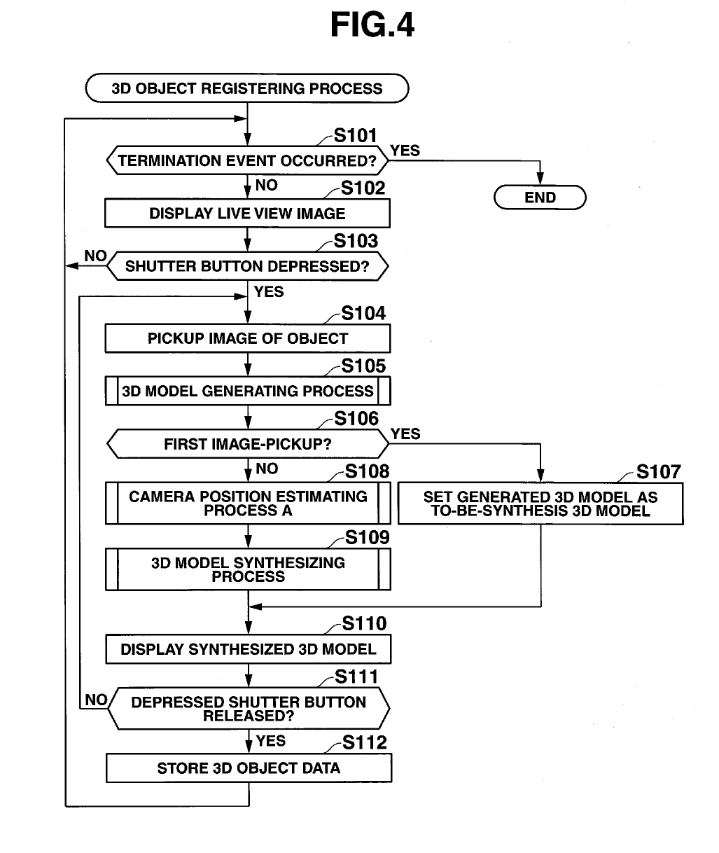

FIG. 4 is a flowchart showing a flow of the 3D object registering process. The 3D object registering process is started upon selection of the 3D object registering mode by the user who operates the operation unit 330 like the operation keys 332.

In the 3D object registering process, while the shutter button 331 is being depressed, image-pickup of the object, generation of a 3D model, synthesis of the generated 3D models, unification of feature points, and a pre-view display of the 3D model having undergone synthesis are repeatedly executed. A 3D model which is obtained by an image-pickup at first and which will be a base of synthesis is referred to as a to-be-synthesis 3D model. Moreover, a 3D model obtained by an image pickup at a second time or later and synthesized with the to-be-synthesis 3D model is referred to as a synthesis 3D model. It is presumed that the user successively picks up images of the object while moving the view point to the object, i.e., while changing the position and posture of the stereo camera 1.

In step S101, the control unit 210 determines whether or not a termination event has occurred. The termination event occurs when, for example, the user gives a mode change operation to a play mode, etc., or when the stereo camera 1 is powered off.

When the termination event has occurred (step S101: YES), this process ends. Conversely, when no termination event has occurred (step S101: NO), the control unit 210 causes the display unit 310 to display an image (i.e., a live view image) based on image data obtained through either one image-pickup unit (e.g., the first image-pickup unit 100A) (step S102).

In step S103, the control unit 210 determines whether or not the shutter button 331 is depressed. When the shutter button 331 is not depressed (step S103: NO), the control unit 210 executes the process in the step S101 again. Conversely, when the shutter button 331 is depressed (step S103: YES), the control unit 210 controls the first image-pickup unit 100A, the second image-pickup unit 100B, and the image processing unit 220 in order to pick up images of the object (step S104). As a result, two parallel and corresponding images (pair images) are obtained. The obtained pair images are stored in, for example, the image memory 230. In the following explanation, between the pair images, an image obtained by an image-pickup by the first image-pickup unit 100A is referred to as an image A and an image obtained by an image-pickup by the second image-pickup unit 100B is referred to as an image B.

The control unit 210 executes a 3D model generating process based on the pair images stored in the image memory 230 (step S105).

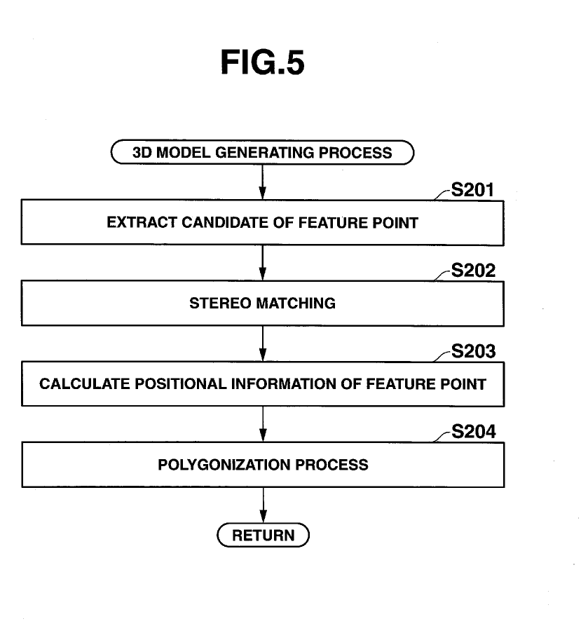

An explanation will be given of the 3D model generating process with reference to the flowchart of FIG. 5. The 3D model generating process is for generating a 3D model based on the pair of pair images. That is, the 3D model generating process can be deemed as a process of generating a 3D model as viewed from a camera position.

First, the control unit 210 extracts candidates of a feature point (step S201). For example, the control unit 210 performs corner detection on the image A. More specifically, the control unit 210 extracts feature points using, for example, a Harris corner detect function. In this case, a point at which a corner feature amount is equal to or greater than a predetermined threshold and becomes maximum within a predetermined radius is selected as a corner point. Accordingly, a tip, etc., of the object is extracted as a feature point characteristic to other points.

Next, the control unit 210 performs stereo matching, and searches, from the image B, a point (a corresponding point) corresponding to the feature point in the image A (step S202). More specifically, the control unit 210 detects, as a corresponding point, a point having a similarity equal to or greater than a predetermined threshold and maximum (or a difference is equal to or less than a predetermined threshold and minimum) through a template matching. Regarding the template matching, various conventionally well-known techniques, such as a residual sum of absolute values (SAD), a residual sum of squares (SSD), a normalized correlation (NCC or ZNCC), and an orientation code correlation, can be applied.

The control unit 210 calculates positional information of the feature point based on parallax information of the corresponding point detected in the step S202, respective field angles of the first and second image-pickup units 100A and 100B, and a base length, etc. (step S203). The positional information of the calculated feature point is stored in, for example, the memory unit 250. At this time, as additional information of the feature point, information on a color may be stored in association with the positional information.

The control unit 210 executes Delaunay triangulation based on the calculated positional information of the feature point, and executes a polygonization process (step S204). Polygon information (a 3D model) generated through this process is stored in, for example, the memory unit 250. The control unit 210 terminates the 3D model generating process when completing the polygonization process.

When the 3D model generating process completes, the control unit 210 determines whether or not an image-pickup is a first image-pickup (step S106 in FIG. 4). When it is a first image-pickup (step S106: YES), the control unit 210 sets the 3D model generated through the 3D model generating process as a to-be-synthesis 3D model (step S107).

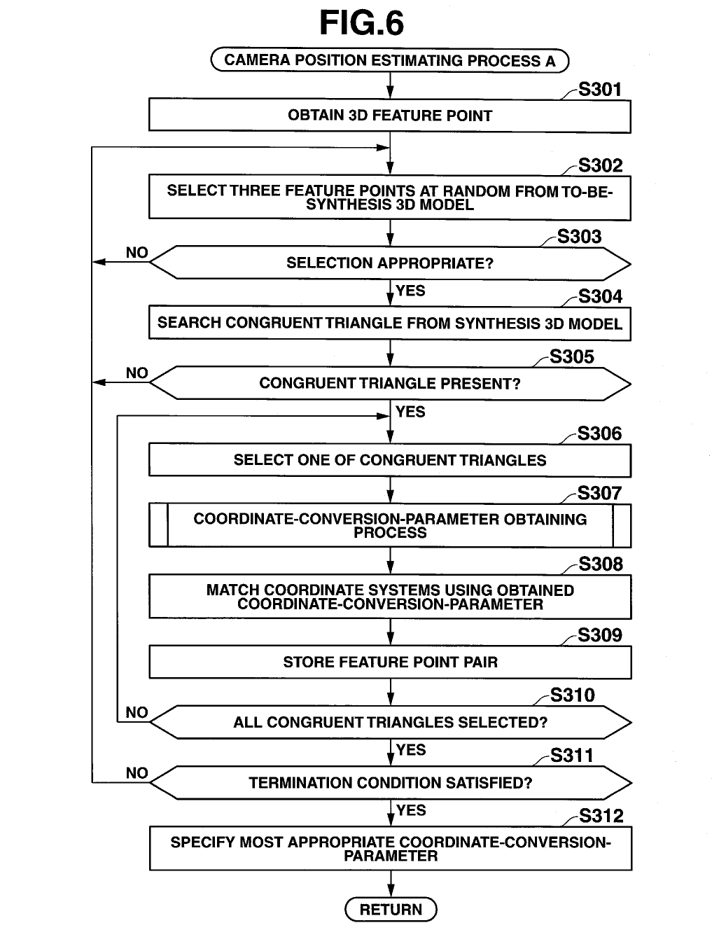

Conversely, when it is not the first image-pickup (step S106: NO), the control unit 210 executes a camera position estimating process A (step S108). The camera position estimating process A will be explained with reference to the flowchart of FIG. 6. In the camera position estimating process A, the relative position and posture of the stereo camera 1 at the time of present image-pickup are obtained relative to the position and posture of the stereo camera 1 at the time of the first image-pickup. The operation of obtaining the relative position and posture is same as an operation of obtaining a coordinate conversion parameter that converts the coordinates of a 3D model obtained at the time of present image-pickup into coordinates in the coordinate system of a 3D model obtained at the time of first image-pickup.

First, the control unit 210 obtains feature points (first and second feature points) on a 3D space from both to-be-synthesis 3D model and synthesis 3D model (step S301). For example, among the feature points of the to-be-synthesis 3D model (or the synthesis 3D model), the control unit 210 selects a point having a high corner intensity and a high stereo-matching consistency. Alternatively, the control unit 210 may execute matching based on a SURF (Speeded-Up Robust Features) feature amount in consideration of an epipolar line constraint between the pair images, thereby obtaining a feature point.

When completing the process in the step S301, the control unit 210 selects three feature points at random from the to-be-synthesis 3D model (step S302). Next, the control unit 210 determines whether or not such a selection is appropriate (step S303). It is determined in this step that selection of the three feature points is appropriate if it satisfies both of the conditions (A) and (B) explained below.

The condition (A) is that the area of a triangle having the three feature points as vertices is not too small, i.e., is equal to or greater than a predetermined area. The condition (B) is that the triangle having the three feature points as vertices has no extraordinary keen angle, i.e., has an angle equal to or greater than a predetermined angle.

Based on the result of the above-explained determination, when such a selection is not appropriate (step S303: NO), the control unit 210 executes the process in the step S302 again. Conversely, when such a selection is appropriate (step S303: YES), the control unit 210 searches a triangle (congruent triangle) congruence with a triangle having the three feature points selected in the step S302 among triangles having three feature points of the synthesis 3D model as vertices (step S304). For example, when respective three sides of both triangles are substantially same, it is determined that both triangles are congruence. The process in the step S304 can be deemed as a process of searching three points corresponding to the three feature points selected from the to-be-synthesis 3D model in the step S302 among the feature points of the synthesis 3D model.

The control unit 210 can speed up the searching process by narrowing down the candidates of the triangle based on a feature point, color information therearound, or a SURF feature amount. Information indicating the searched triangle (typically, information indicating coordinates of three feature points configuring vertices of the triangle on the 3D space) is stored in, for example, the memory unit 250. When there are multiple congruent triangles, pieces of information indicating all triangles are stored in the memory unit 250.

The control unit 210 determines through the above-explained selection whether or not there is at least one congruent triangle (step S305). When the number of searched congruent triangles is equal to or greater than a predetermined number, the control unit 210 may determine that a congruent triangle is not present (cannot be found).

When there are congruent triangles (step S305: YES), the control unit 210 selects one (step S306). Conversely, when there is no congruent triangle (step S305: NO), the control unit 210 executes the process in the step S302 again.

When a congruent triangle is selected, the control unit 210 executes a coordinate-conversion-parameter obtaining process (step S307). The coordinate-conversion-parameter obtaining process is for obtaining a coordinate conversion parameter that converts the coordinates of the synthesis 3D model into coordinates in the coordinate system of the to-be-synthesis 3D model. The coordinate-conversion-parameter obtaining process is executed for each combination of three feature points selected in the step S302 and congruent triangle selected in the step S306. The coordinate conversion parameter is for obtaining a rotation matrix R and a moving vector t satisfying a formula (3) with respect to a corresponding point pair (feature point pair, vertex pair) given from formulae (1) and (2). p and p′ in formulae (1) and (2) have coordinates in the 3D space corresponding to respective camera view points. Note that N is a pair number of a corresponding point pair.

$$\begin{matrix}{p}_{i} = [ \begin{matrix}{x}_{i} \\ {y}_{i} \\ {z}_{i}\end{matrix} ] ( i = 1 , 2 , … , N ) & ( 1 ) \\ {p}_{i}^{′} = [ \begin{matrix}{x}_{i}^{′} \\ {y}_{i}^{′} \\ {z}_{i}^{′}\end{matrix} ] ( i = 1 , 2 , … , N ) & ( 2 ) \\ {p}_{i} = {Rp}_{i}^{′} + t & ( 3 )\end{matrix}$$

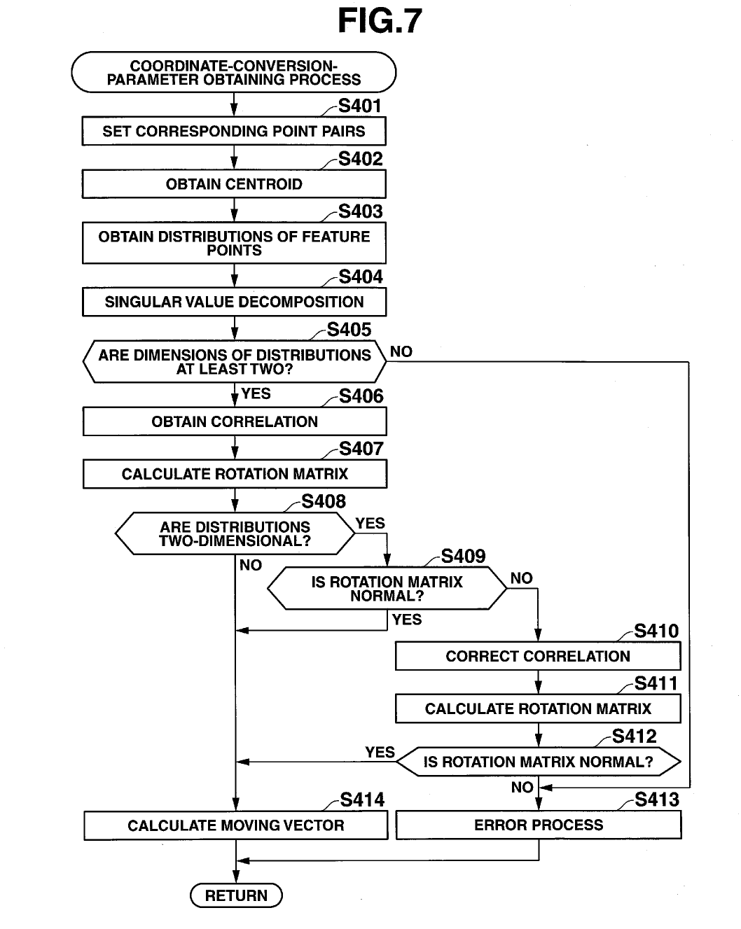

FIG. 7 is a flowchart showing a flow of the coordinate-conversion-parameter obtaining process. First, as is indicated by formulae (4) and (5), the control unit 210 sets a corresponding point pair (step S401). c1 and c2 are matrixes where a corresponding column vector has coordinates of a corresponding point. It is difficult to directly obtain the rotation matrix R and the moving vector t from this matrix. However, since respective distributions of p and p′ are substantially same, when it is rotated with the centroid of the corresponding point being aligned, the corresponding point can be superimposed. By utilizing this fact, the rotation matrix R and the moving vector t are obtained.

c1=[p₁p₂ . . . p_{N}] (4)

c2=[p′₁p′₂ . . . p′_{N}] (5)

That is, using formulae (6) and (7), the control unit 210 obtains centroids t1 and t2 that are respective centroids of the feature points (step S402).

$$\begin{matrix}t 1 = \frac{1}{N} {\sum }_{i = 1}^{N} {p}_{i} & ( 6 ) \\ t 2 = \frac{1}{N} {\sum }_{i = 1}^{N} {p}_{i}^{′} & ( 7 )\end{matrix}$$

Next, using formulae (8) and (9), the control unit 210 obtains distributions d1 and d2 that are respective distributions of the feature points (step S403). As explained above, a relationship that is a formula (10) is satisfied between the distribution d1 and the distribution d2.

d1=[(p₁−t1)(p₂−t1) . . . (p_{N}−t1)] (8)

d2=[(p′₁−t2)(p′₂−t2) . . . (p′_{N}−t2)] (9)

d1=Rd2 (10)=

Next, the control unit 210 executes singular value decomposition on the distributions d1 and d2 using formulae (11) and (12) (step S404). It is presumed that singular values are arranged in a descending order. In the following formulae, a symbol * indicates a complex conjugate transposition.

d1=U₁S₁V₁* (11)

d2=U₂S₂V₂* (12)

Next, the control unit 210 determines whether or not the dimensions of the distributions d1 and d2 are equal to or greater than two dimension (step S405). The singular values correspond to the expanse of the distribution. Hence, a determination is made based on a ratio between a maximum singular value and another singular value and the largeness of the singular value. For example, when the second largest singular value is equal to or greater than a predetermined value and the ratio with the maximum singular value is within a predetermined range, it is determined that the dimension of the distribution is equal to or greater than two dimension.

When the dimensions of the distributions d1 and d2 are not equal to or greater than two dimension (step S405: NO), the control unit 210 is unable to obtain the rotation matrix R, so that the control unit 210 executes an error process (step S413), and terminates the coordinate-conversion-parameter obtaining process.

Conversely, when the dimensions of the distributions d1 and d2 are equal to or greater than two dimension (step S405: YES), the control unit 210 obtains an correlation K (step S406). From the formulae (10) to (12), the rotation matrix R can be expressed as a formula (13). When the correlation K is defined as a formula (14), the rotation matrix R can be expressed as a formula (15).

R=U₁S₁V₁*V₂S₂⁻¹U₂* (13)

K=S₁V₁*V₂S₂⁻¹ (14)

R=U₁KU₂* (15)

An eigenvector U corresponds to the eigenvectors of the distributions d1 and d2, and is associated by the correlation K. The element of the correlation K is 1 or −1 when the eigenvector corresponds, and is 0 in other cases. When the distributions d1 and d2 are equal, the singular values are equal and S are also equal. In practice, the distributions d1 and d2 include errors, so that the errors are rounded. In consideration of the above-explained condition, the correlation K can be expressed as a formula (16). That is, the control unit 210 calculates the formula (16) in the step S406.

K=round((first to third rows of V₁*)(first to third columns of V₂)) (16)

When completing the process in the step S406, the control unit 210 calculates the rotation matrix R (step S407). More specifically, based on the formulae (15) and (16), the control unit 210 calculates the rotation matrix R. Information indicating the obtained rotation matrix R through the calculation is stored in, for example, the memory unit 250.

When completing the process in the step S407, the control unit 210 determines whether or not the distributions d1 and d2 are two dimensional (step S408). For example, when the minimum singular value is equal to or smaller than a predetermined value or a ratio with the maximum singular value is out of a predetermined range, it is determined that the distributions d1 and d2 are two dimensional.

When the distributions d1 and d2 are not two dimensional (step S408: NO), the control unit 210 calculates the moving vector t (step S414). When the distributions d1 and d2 are not two dimensional, it suggests that the distributions d1 and d2 are three dimensional (3D). Moreover, p and p′ satisfy the relationship expressed by a formula (17). When the formula (17) is transformed, it becomes a formula (18). Based on a correspondence between the formula (3) and the formula (18), the moving vector t can be expressed as a formula (19).

(pᵢ−t1)=R(p′ᵢ−t2) (17)

pᵢ=Rp′ᵢ+(t1−Rt2) (18)

t=t1−Rt2 (19)

Conversely, when the distributions d1 and d2 are two dimensional (step S408: YES), the control unit 210 verifies the rotation matrix R and determine whether or not the rotation matrix R is normal (step S409). When the distributions are two dimensional, one of the singular values becomes 0, so that, as can be found from the formula (14), the correlation becomes indefinite. That is, the element of K at the third row and the third column is either 1 or −1, but there is no guarantee that a correct sign is allocated in the formula (16). Hence, it is necessary to verify the rotation matrix R. Such a verification is carried out by checking of cross product relationship of the rotation matrix R and recalculation based on the formula (10). Checking of the cross product relationship is checking of whether or not the column vector (and the row vector) of the rotation matrix R satisfies a restraint by the coordinate system. In a right-hand coordinate system, the cross product of the first-column vector by the second-column vector becomes equal to the third-column vector.

When the rotation matrix R is normal (step S409: YES), the control unit 210 calculates the moving vector t (step S414), and terminates the coordinate-conversion-parameter obtaining process.

Conversely, when the rotation matrix R is abnormal (step S409: NO), the control unit 210 corrects the correlation K (step S410). In the present embodiment, the sign of the element of the correlation K at the third column and the third row is inverted.

After the process in the step S410, the control unit 210 calculates the rotation matrix R using the corrected correlation K (step S411). Next, the control unit 210 again determines whether or not the rotation matrix R is normal (step S412).

When the rotation matrix R is normal (step S412: YES), the control unit 210 calculates the moving vector t (step S414), and terminates the coordinate-conversion-parameter obtaining process.

Conversely, when the rotation matrix R is abnormal (step S412: NO), the control unit 210 executes an error process (step S413), and terminates the coordinate-conversion-parameter obtaining process.

Returning to the flow in FIG. 6, when completing the above-explained coordinate-conversion-parameter obtaining process, the control unit 210 executes a process of matching a coordinate system with another coordinate system using the obtained coordinate conversion parameter (step S308). More specifically, the control unit 210 converts, using the formula (3), the coordinates of the feature points of the synthesis 3D model into the coordinates in the coordinate system of the to-be-synthesis 3D model.

After the process in the step S308, the control unit 210 stores the feature point pair (step S309). The feature point pair includes a feature point of the to-be-synthesis 3D model and a feature point which has a distance to the feature point of the to-be-synthesis 3D model equal to or shorter than a predetermined value and which is closest to such a point among the feature points of the synthesis 3D model having undergone coordinate conversion. The larger the number of feature point pairs is, the more the possibility that selection of the three feature points in the step S302, i.e., selection of the congruent triangle in the step S306 is estimated as appropriate increases. The feature point pair is stored in the memory unit 250, etc., together with the obtained condition of the coordinate conversion parameter (i.e., selection of the three feature points in the step S302 and selection of the congruent triangle in the step S306).

Next, the control unit 210 determines whether or not all congruent triangles searched and found in the step S304 are selected in the step S306 (step S310). When there is a non-selected congruent triangle (step S310: NO), the control unit 210 executes the process in the step S306 again.

Conversely, when all congruent triangles are selected (step S310: YES), the control unit 210 determines whether or not a termination condition is satisfied (step S311). In the present embodiment, when the number of feature point pairs becomes equal to or greater than a predetermined number or when the processes in the steps S302, S304, S307, and the like are executed by a predetermined number, the termination condition is satisfied.

When the termination condition is not satisfied (step S311: NO), the control unit 210 executes the process in the step S302 again.

Conversely, when the termination condition is satisfied (step S311: YES), the control unit 210 specifies the most appropriate coordinate conversion parameter (step S312). For example, a coordinate conversion parameter that obtains the largest number of feature point pairs, a coordinate conversion parameter that makes an average distance between the feature point pairs minimum, or the like is specified. In other words, a coordinate conversion parameter based on the most appropriate selection of the three feature points in the step S302 and the most appropriate selection of the congruent triangle in the step S306 is specified. The coordinate conversion parameter includes the rotation matrix R and the moving vector t.

When completing the process in the step S312, the control unit 210 terminates the camera position estimating process A.

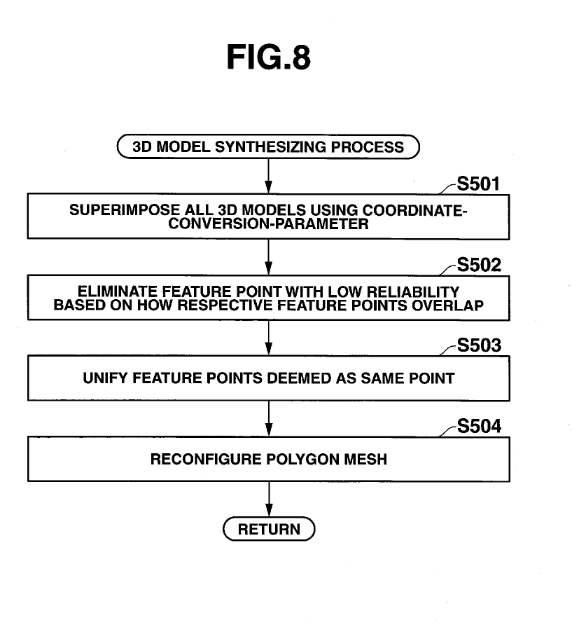

Returning to FIG. 4, when completing the above-explained camera position estimating process A (step S108), the control unit 210 executes a 3D model synthesizing process (step S109). An explanation will now be given of the 3D model synthesizing process with reference to the flowchart of FIG. 8.

First, the control unit 210 superimposes all 3D models using the coordinate conversion parameters (step S501). Each 3D model is subjected to coordinate conversion using the corresponding coordinate conversion parameter, and is synthesized. For example, in the case of a second image-pickup, a synthesis 3D model having undergone coordinate conversion and generated based on the pair images picked up at the time of second image-pickup is superimposed on a to-be-synthesis 3D model generated based on the pair images picked up at the time of first image-pickup. Moreover, in the case of a third image-pickup, a synthesis 3D model having undergone coordinate conversion and generated based on the pair images picked up at the time of the second image-pickup is superimposed on a to-be-synthesis 3D model generated based on the pair images picked up at the time of the first image-pickup, and a synthesis 3D model having undergone coordinate conversion and generated based on the pair images picked up at the time of the third image-pickup is further superimposed.

Next, the control unit 210 eliminates feature points with a low reliability based on how respective feature points overlap (step S502). For example, based on the distribution of, with respect to an emphasized feature point on a 3D model, the feature points closest to that point on another 3D model, a Mahalanobis' generalized distance of the emphasized feature point is calculated and when the Mahalanobis' generalized distance is equal to or greater than a predetermined value, it is determined that the emphasized feature point has a low reliability. The feature point having a distance from the emphasized feature point equal to or larger than a predetermined value may be excluded from the closest feature points. Moreover, when the number of closest feature points is small, it may be determined that the reliability is low. A process of eliminating the feature point in practice is executed after it is determined for all feature points whether or not each feature point is eliminated.

Next, the control unit 210 unifies feature points which can be deemed as the same feature point (step S503). For example, the feature points within a predetermined distance are taken as points all belonging to a group that represents the same feature point, and the centroid of those feature points is set as a new feature point.

After the process in the step S503, the control unit 210 reconfigures polygon meshes (step S504). That is, a polygon is generated based on new feature points obtained in the step S503. After the process in the step S504, the control unit 210 terminates the 3D model synthesizing process.

Information representing the 3D model generated through the 3D model generating process in FIG. 5 is maintained and is basically unchanged by what corresponds to all image-pickup (by what corresponds to all view points) while the shutter button 331 is depressed. That is, the above-explained 3D model synthesizing process is for separately generating a high-definition 3D model to be displayed or to be stored based on the 3D models by what corresponds to all image-pickup.

Returning to FIG. 4, when completing the process in the step S107 or S109, the control unit 210 displays a synthesized 3D model (step S110). More specifically, the control unit 210 causes the display unit 310 to display a 3D model obtained through the 3D model generating process (step S105) or the 3D model synthesizing process (step S109) (step S110). Accordingly, the user can figure out how much precise a generated 3D model is up to a present image-pickup.

After the process in the step S110, the control unit 210 determines whether or not the shutter button 331 being depressed is released (step S111). When the shutter button 331 being depressed is not released (step S111: NO), the control unit 210 executes the process in the step S104 again.

Conversely, when the shutter button 331 being depressed is released (step S111: YES), the control unit 210 stores 3D object data containing the 3D model obtained through the 3D model synthesizing process and information (feature point information) on the unified feature points in the external memory unit 260, etc. (step S112), and the process returns to the step S101.

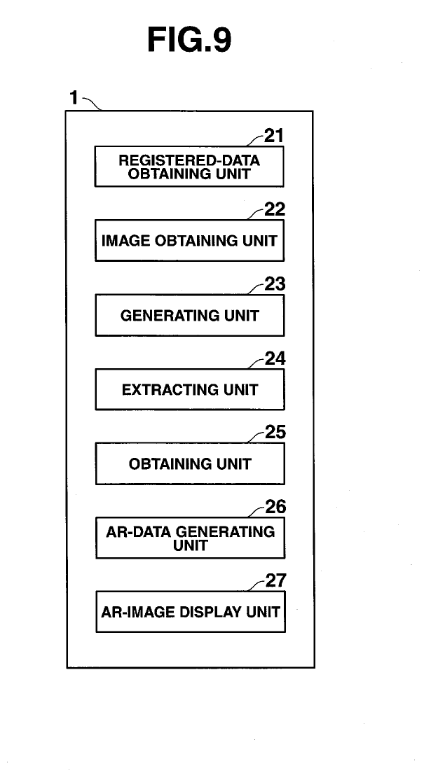

Next, an explanation will be given of an operation related to the 3D object manipulating mode. FIG. 9 is a block diagram showing a functional configuration of the stereo camera 1 for realizing the operation related to the 3D object manipulating mode.

In the above operation, as shown in FIG. 9, the stereo camera 1 includes a registered-data obtaining unit 21, an image obtaining unit 22, a generating unit 23, an extracting unit 24, an obtaining unit 25, an AR-data generating unit 26, and an AR-image display unit 27.

The registered-data obtaining unit 21 reads the 3D object data containing the 3D model (a first 3D model) generated through the above-explained 3D object registering process and the feature point information from the external memory unit 260, etc.

The image obtaining unit 22 obtains two images (pair images) having a parallax for the same object. The generating unit 23 generates a 3D model (a second 3D model) of the object based on the pair images obtained by the image obtaining unit 22.

The extracting unit 24 extracts a plurality of feature points from the second 3D model generated by the generating unit 23. The obtaining unit 25 obtains, based on the plurality of feature points of the second 3D model extracted by the extracting unit 24 and a plurality of feature points of the 3D object data read by the registered-data obtaining unit 21, a coordinate conversion parameter that converts the coordinates of the first 3D model into coordinates in the coordinate system of the second 3D model.

The AR-data generating unit 26 generates AR data based on the coordinate conversion parameter obtained by the obtaining unit 25 and the second 3D model. The AR-image display unit 27 displays an image (an AR image) based on the AR data generated by the AR-data generating unit 26 on the display unit 310.

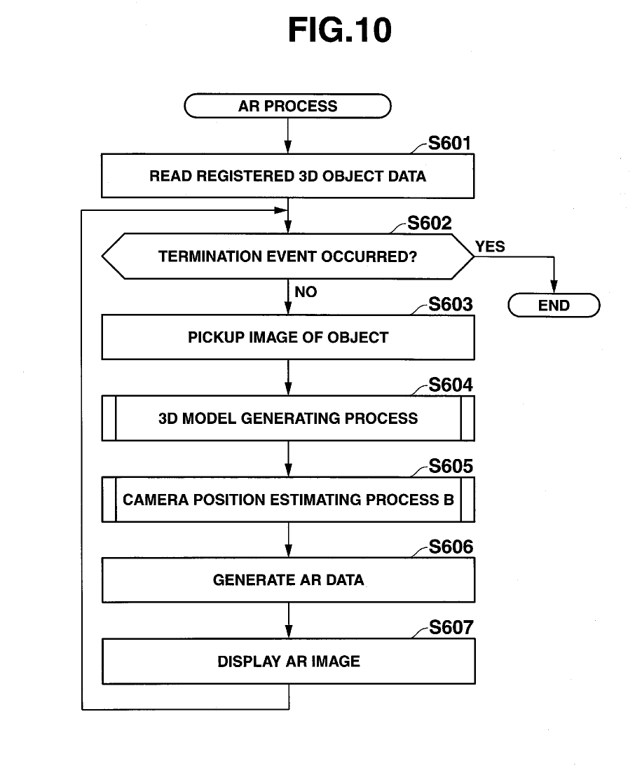

FIG. 10 is a flowchart showing a flow of a process (an AR process) at the time of 3D object manipulating mode. The AR process is triggered upon selection of the 3D object manipulating mode by the user operating the operation unit 330 like the operation keys 332.

First, the control unit 210 reads 3D object data obtained through the above-explained 3D object registering process from the external memory 260, etc., and extracts such data in the image memory 230 (step S601).

Next, the control unit 210 determines whether or not a termination event has occurred (step S602). The termination event occurs when, for example, the user operates the stereo camera 1 in order to change the mode to a play mode, or when the stereo camera 1 is powered off.

When the termination event has occurred (step S602: YES), this process is terminated. Conversely, when no termination event has occurred (step S602: NO), the control unit 210 controls the first image-pickup unit 100A, the second image-pickup unit 100B, and the image processing unit 220 in order to pick up images of the object (step S603). As a result, pair images are obtained and the obtained pair images are stored in the image memory 230.

The control unit 210 executes a 3D model generating process based on the pair images stored in the image memory 230 (step S604). The detail of the 3D model generating process is same as that of the 3D model generating process (see FIG. 5) in the above-explained 3D object registering process, so that the duplicated explanation will be omitted.

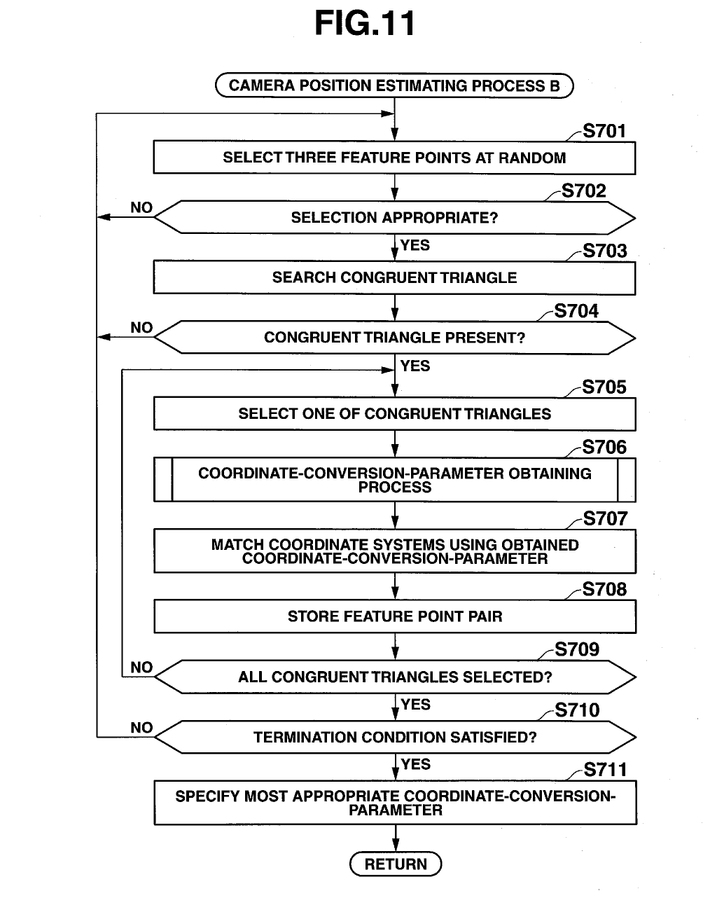

Next, the control unit 210 executes a camera position estimating process B (step S605). FIG. 11 is a flowchart showing a flow of the camera position estimating process B. First, the control unit 210 selects three feature points at random among feature points obtained at the present time (i.e., relating to the present image-pickup) (step S701). Next, the control unit 210 determines whether or not such selection is appropriate (step S702). The determination condition in this step is same as that of the above-explained camera position estimating process A.

Based on the above determination, when the selection is inappropriate (step S702: NO), the control unit 210 executes the process in the step S701 again. Conversely, when the selection is appropriate (step S702: YES), the control unit 210 searches a triangle (congruent triangle) congruence with a triangle having the three feature points selected in the process of the step S701 as vertices among triangles having the three feature points of the read 3D object data as vertices (step S703). For example, when respective three sides of both triangles have substantially equal length, it is determined that both triangles are congruent.

Like the above-explained camera position estimating process A, by narrowing down the candidates of the triangle based on a feature point, information on a color therearound, or a SURF feature amount, etc., the control unit 210 speeds up the searching process. Information indicating a searched triangle (typically, information indicating coordinates of three feature points on a 3D space and configuring vertices of the triangle) is stored in, for example, the memory unit 250. When there are a plurality of congruent triangles, pieces of information on all triangles are stored in the memory unit 250.

The control unit 210 determines through the above-explained searching whether or not there is at least one congruent triangle (step S704). When the number of searched congruent triangles is equal to or greater than a predetermined number, the control unit 210 may determine that a congruent triangle is not present (cannot be found).

When there are congruent triangles (step S704: YES), the control unit 210 selects one (step S705). Conversely, when there is no congruent triangle (step S704: NO), the control unit 210 executes the process in the step S701 again.

When a congruent triangle is selected, the control unit 210 executes a coordinate-conversion-parameter obtaining process (step S706). The detail of the coordinate-conversion-parameter obtaining process is same as that of the coordinate-conversion-parameter obtaining process (see FIG. 7) in the above-explained camera position estimating process A, so that the duplicated explanation will be omitted.

When completing the coordinate-conversion-parameter obtaining process, the control unit 210 executes a process of matching a coordinate system with another coordinate system using the obtained coordinate conversion parameter (step S707). That is, using the formula (3), the control unit 210 converts the coordinates of the feature points (registered feature points) of the 3D object data into coordinates in the coordinate system of the feature point obtained at present time.

After the process in the step S707, the control unit 210 stores the obtained feature point pair in the memory unit 250, etc. (step S708). The feature point pairs include the feature point obtained at present time and a feature point which has a distance from that feature point obtained at present time equal to or shorter than a predetermined value and which is closest thereto among the registered feature points having undergone coordinate conversion.

Next, the control unit 210 determines whether or not all congruent triangles searched and found in the step S703 are selected in the step S705 (step S709). When there is a non-selected congruent triangle (step S709: NO), the control unit 210 executes the process in the step S705 again.

Conversely, when all congruent triangles are selected (step S709: YES), the control unit 210 determines whether or not a termination condition is satisfied (step S710). In the present embodiment, when the number of feature point pairs becomes equal to or greater than a predetermined number or when the processes in the steps S701, S703, S706, and the like are executed by a predetermined number, the termination condition is satisfied.

When the termination condition is not satisfied (step S710: NO), the control unit 210 executes the process in the step S701 again.

Conversely, when the termination condition is satisfied (step S710: YES), the control unit 210 specifies the most appropriate coordinate conversion parameter (step S711). For example, a coordinate conversion parameter that obtains the largest number of feature point pairs, or a coordinate conversion parameter that makes an average distance between the feature point pairs minimum is specified. In other words, a coordinate conversion parameter based on the most appropriate selection of the three feature points in the step S701 and the most appropriate selection of the congruent triangle in the step S705 is specified. Like the above-explained camera position estimating process A, the coordinate conversion parameter includes the rotation matrix R and the moving vector t.

When completing the process in the step S711, the control unit 210 terminates the camera position estimating process B.

Returning to the flow in FIG. 10, the control unit 210 generates AR data using the coordinate conversion parameter obtained through the camera position estimating process B (step S606). Examples of the AR data are image data having information on a portion where the object appears in a present picked-up image superimposed thereon, image data having a portion where the object appears replaced with a virtual object image, and image data which changes the color and the pattern of a portion where the object appears or enlarges such a portion.

Next, the control unit 210 causes the display unit 310 to display an image (an AR image) based on the generated AR data (step S607), and executes the process in the step S602 again.

As explained above, according to the stereo camera 1 of the embodiment of the present invention, by causing the stereo camera 1 to execute the process (the 3D object registering process) in the 3D object registering mode, the user can easily obtain 3D feature points of a desired object in multi-view (multi-visual-line) 3D modeling. Next, the position and posture of the stereo camera 1 are estimated based on the 3D feature points obtained at present time and the 3D feature points obtained previously in the process (the AR process) in the 3D object manipulating mode. Accordingly, it is possible to precisely estimate the position and posture of the stereo camera 1 without using a marker, and the position of the virtual object to be superimposed can precisely follow a change in the view point of the user.

The present invention is not limited to the above-explained embodiment, and can be changed and modified in various forms without departing from the scope and spirit of the present invention.

For example, unlike the stereo camera 1 of the above-explained embodiment, it is not always necessary to have both functions of the 3D object registering mode and the 3D object manipulating mode. For example, a stereo camera (a first camera) having only 3D object registering mode function may obtain 3D feature points of a desired object in multi-view 3D modeling, and another stereo camera (a second camera) having only 3D object manipulating mode function may use the 3D feature points obtained by the first camera.

In this case, the second camera is not limited to a stereo camera, and may be a monocular camera. In the case of a monocular camera, association of 3D feature points obtained by the first camera with 2D (two-dimensional) feature points obtained by a present image-pickup may be carried out using a projection-transform-parameter estimating algorithm based on, for example, RANSAC.

At the time of the start of an operation in the 3D object manipulating mode, when plural pieces of 3D object data are registered in advance, the user may be prompted to specify desired 3D object data. Alternatively, all pieces of registered 3D object data may be used sequentially in order to automatically estimate the position and posture of the camera, and when a good result is obtained, AR data may be generated.

Furthermore, a conventional stereo camera, etc., can function as an AR process apparatus of the present invention. That is, the program run by the control unit 210 is applied to a conventional stereo camera, and the CPU or the like of the stereo camera runs the program, so that the stereo camera can function as the AR process apparatus of the present invention.

How to distribute such a program is optional. For example, the program stored in a non-transitory computer-readable storage medium, such as a CD-ROM (Compact Dick Read-Only Memory), a DVD (Digital Versatile Disk), an MO (Magneto Optical disk), or a memory card can be distributed. Alternatively, the program may be distributed over a communication network like the Internet.

In this case, when the above-explained function related to the present invention is beard by an OS (an Operating System) and an application program or realized by a cooperative operation of the OS and the application program, only application program portion may be stored in a storage medium, etc.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. An AR process apparatus comprising:
an image obtaining unit that obtains a set of images which comprises two or more images having a parallax for an object;
a generating unit that generates a 3D model of the object based on the set of images obtained by the image obtaining unit;
an extracting unit which (a) selects a 3D model of the object initially generated by the generating unit as a to-be-synthesis 3D model, (b) extracts a plurality of first feature points from the to-be-synthesis 3D model, (c) selects a 3D model of the object subsequently generated by the generating unit as a synthesis 3D model, and (d) extracts a plurality of second feature points from the synthesis 3D model;
an obtaining unit that obtains, based on (i) the plurality of first feature points of the to-be-synthesis 3D model and (ii) the plurality of second feature points of the synthesis 3D model extracted by the extracting unit, a coordinate conversion parameter that converts a coordinate of the synthesis 3D model into a coordinate in a coordinate system of the to-be-synthesis 3D model;
a converting unit that converts the coordinate of the synthesis 3D model into the coordinate in the coordinate system of the to-be-synthesis 3D model using the coordinate conversion parameter obtained by the obtaining unit;
a synthesizing unit which (a) generates a synthesized-3D model of the object by synthesizing a plurality of synthesis 3D models, whose coordinates have been converted by the converting unit, with the to-be-synthesis 3D model, and (b) unifies the feature points; and
a storing unit that stores (a) the synthesized-3D model of the object generated by the synthesizing unit and (b) information indicating the unified feature points in a memory device.

2. The AR process apparatus according to claim 1, wherein the obtaining unit (a) selects three of the first feature points from the plurality of the extracted first feature points, (b) selects three of the second feature points, which form three vertices of a triangle corresponding to a triangle comprising vertices having the selected first feature points, from the plurality of extracted second feature points, and (c) obtains a coordinate conversion parameter that matches coordinates of the selected three second feature points with coordinates of the selected three first feature points.

3. The AR process apparatus according to claim 2, wherein the obtaining unit (a) selects three first feature points at random from the plurality of the extracted first feature points, (b) executes a process of obtaining the coordinate conversion parameter multiple times, and (c) selects one of a plurality of coordinate conversion parameters obtained through the multiple processes.

4. The AR process apparatus according to claim 3, wherein the obtaining unit selects, from among the plurality of coordinate conversion parameters, such a coordinate conversion parameter that the coordinates of the plurality of second feature points, which are converted by the converting unit by using the selected coordinate conversion parameter, best matches to the coordinates of the plurality of first feature points.

5. The AR process apparatus according to claim 1, wherein the synthesizing unit (a) groups the plurality of first feature points and the plurality of second feature points into a plurality of groups so that corresponding feature points belong to a same group, (b) obtains respective centroids of the plurality of groups, and (c) generates a new 3D model by using the plurality of obtained centroids as a plurality of new feature points.

6. An AR process apparatus comprising:
a registered-data obtaining unit that obtains 3D object data previously registered, which includes (a) a first 3D model of an object and (b) information indicating a plurality of feature points of the first 3D model;
an image obtaining unit that obtains a set of images which comprises two or more images having a parallax for the object;
a generating unit that generates a second 3D model of the object based on the set of images obtained by the image obtaining unit;
an extracting unit that extracts a plurality of feature points from the second 3D model generated by the generating unit;
an obtaining unit that obtains, based on (i) the plurality of feature points of the second 3D model extracted by the extracting unit and (ii) a plurality of feature points related to the 3D object data obtained by the registered-data obtaining unit, a coordinate conversion parameter that converts a coordinate of the first 3D model into a coordinate in a coordinate system of the second 3D model;
an AR-data generating unit that generates AR data based on the coordinate conversion parameter obtained by the obtaining unit and the second 3D model; and
an AR-image display unit that displays an image based on the AR data generated by the AR-data generating unit.

7. An AR process method comprising:
obtaining a set of images which comprises two or more images having a parallax for an object;
generating a 3D model of the object based on the set of obtained images;
selecting a 3D model of the object initially generated as a to-be-synthesis 3D model, and extracting a plurality of first feature points from the to-be-synthesis 3D model;
selecting a 3D model of the object subsequently generated as a synthesis 3D model, and extracting a plurality of second feature points from the synthesis 3D model;
obtaining, based on (i) the plurality of extracted first feature points of the to-be-synthesis 3D model and (ii) the plurality of extracted second feature points of the synthesis 3D model, a coordinate conversion parameter that converts a coordinate of the synthesis 3D model into a coordinate in a coordinate system of the to-be-synthesis 3D model;
converting the coordinate of the synthesis 3D model into the coordinate in the coordinate system of the to-be-synthesis 3D model using the obtained coordinate conversion parameter;
(a) generating a synthesized-3D model of the object by synthesizing a plurality of synthesis 3D models, whose coordinates have been converted, with the to-be-synthesis 3D model, and (b) unifying the feature points; and
storing (a) the synthesized-3D model of the object generated and (b) information indicating the unified feature points in a memory device.

8. An AR process method comprising:
obtaining 3D object data previously registered, which includes (a) a first 3D model of an object and (b) information indicating a plurality of feature points of the first 3D model;
obtaining a set of images which comprises two or more images having a parallax for the object;
generating a second 3D model of the object based on the set of images obtained;
extracting a plurality of feature points from the generated second 3D model;
obtaining, based on (i) the plurality of extracted feature points of the second 3D model and (ii) a plurality of feature points related to the obtained 3D object data, a coordinate conversion parameter that converts a coordinate of the first 3D model into a coordinate in a coordinate system of the second 3D model;
generating AR data based on the obtained coordinate conversion parameter and the second 3D model; and
displaying an image based on the generated AR data.

9. A non-transitory computer-readable storage medium with an executable program stored thereon, wherein the program instructs a computer which controls an AR process apparatus to perform the following steps:
obtaining a set of images which comprises two or more images having a parallax for an object;
generating a 3D model of the object based on the set of obtained images;
selecting a 3D model of the object initially generated as a to-be-synthesis 3D model, and extracting a plurality of first feature points from the to-be-synthesis 3D model;
selecting a 3D model of the object subsequently generated as a synthesis 3D model, and extracting a plurality of second feature points from the synthesis 3D model;
obtaining, based on (i) the plurality of extracted first feature points of the to-be-synthesis 3D model and (ii) the plurality of extracted second feature points of the synthesis 3D model, a coordinate conversion parameter that converts a coordinate of the synthesis 3D model into a coordinate in a coordinate system of the to-be-synthesis 3D model;
converting the coordinate of the synthesis 3D model into the coordinate in the coordinate system of the to-be-synthesis 3D model using the obtained coordinate conversion parameter;
(a) generating a synthesized-3D model of the object by synthesizing a plurality of synthesis 3D models, whose coordinates have been converted, with the to-be-synthesis 3D model, and (b) unifying the feature points; and
storing (a) the synthesized-3D model of the object generated and (b) information indicating the unified feature points in a memory device.

10. A non-transitory computer-readable storage medium with an executable program stored thereon, wherein the program instructs a computer which controls an AR process apparatus to perform the following step:
obtaining 3D object data previously registered, which includes (a) a first 3D model of an object and (b) information indicating a plurality of feature points of the first 3D model;
obtaining a set of images which comprises two or more images having a parallax for the object;
generating a second 3D model of the object based on the set of images obtained;
extracting a plurality of feature points from the generated second 3D model;
obtaining, based on (i) the plurality of extracted feature points of the second 3D model and (ii) a plurality of feature points related to the obtained 3D object data, a coordinate conversion parameter that converts a coordinate of the first 3D model into a coordinate in a coordinate system of the second 3D model;
generating AR data based on the obtained coordinate conversion parameter and the second 3D model; and
displaying an image based on the generated AR data.
